(19) United States
(12) Patent Application Publication
(10) Pub. No.: US 2008/0132293 A1
(43) Pub. Date: Jun. 5, 2008

(54) Wireless Headset

(75) Inventors: John D. GUNDLACH, Acton, MA (US); Terrence K. JONES, Jamestown, RI (US); Jack CORRAO, San Diego, CA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: NEWTON PERIPHERALS, LLC, Natick, MA (US)

(21) Appl. No.: 11/851,332

(22) Filed: Sep. 6, 2007

Related U.S. Application Data
(60) Provisional application No. 60/824,730, filed on Sep. 6, 2006.

(51) Int. Cl. H04M 11/00

(52) U.S. Cl. 455/569.1

(57) ABSTRACT

The present disclosure relates to a device, such as a wireless headset that may include a first expanded configuration and a second collapsed configuration. When collapsed the device may be stored and charged in a host device such as a portable laptop computer or cell phone.

### CROSS-REFERENCE TO RELATED APPLICATIONS

The present application claims the benefit of U.S. Provisional Application No. 60/824,730, filed on Sep. 6, 2006, the disclosure of which is incorporated by reference herein.

### FIELD OF INVENTION

The present invention relates to a device that when in a first configuration, such as when expanded, becomes a wireless mono or stereo headset and when in a second configuration, such as when collapsed, stores and charges in a host device such as a laptop computer or cell phone.

### BACKGROUND

The portable computer market continues to grow and appears now outpaces the desktop personal computer market. People want computing mobility that replicates the power and convenience of their home or office computer. One of the burdens of mobility is managing the wires and peripherals that accompany a portable computer. In many cases peripherals are added to the portable computer in an attempt to replace the functions that are present in a desktop machine. To reduce the connection complexity, wireless technologies have become integrated into portable computers. Bluetooth radios have become standard in many laptops available today. In addition, many devices have incorporated rechargeable batteries to alleviate the need to power the peripheral devices from, for example, an AC supply connection or to maintain a supply of replaceable batteries.

VOIP technology (Voice Over Internet Protocol) such as Skype™ and Vonage™ is fast becoming the telephony choice for cost and mobility reasons. VOIP may be operated on virtually any internet connected portable computer. The voice input and audio output require a microphone and speakers. Using the speakers and microphone embedded in the portable computer offers no privacy to the user so it is common to implement a portable wired or wireless headset as an accessory.

In addition, it may be inconvenient for laptop or mobile phone users to carry extra equipment like corded or even wireless headsets to gain privacy during calls. Keeping track of the headsets and other peripherals and keeping them charged and ready to use becomes a burden. Many battery operated wireless headsets (with rechargeable batteries) require a cord connecting the headset to the laptop or wall outlet for charging which adds yet another thing to store, carry and keep track of.

Most portable and handheld computers have expansion slots built-in such as the ExpressCard™ or PC Card slots. The slots may conform to form and protocol standards that may allow third party vendors to create interchangeable accessory devices. Expansion cards may allow the user to increase a device's memory or add different types of communication interfaces. Due to the rise in popularity of the USB interface and the subsequent migration of the accessory market to that interface, most PC card slots sit empty in laptops. Many slots have power that can be used to charge battery operated devices as well as high speed communications buses to interchange data.

### SUMMARY

An aspect of the present disclosure relates to a wireless device. The wireless device may include a housing, a microphone, a transceiver, and a speaker which directs sound through an earpiece movably affixed to said housing, wherein at least a portion of the earpiece maybe configured to fit within a user's ear. In addition, the wireless device may have a physical envelope which may be defined by a length, width and thickness and the earpiece, in an expanded configuration, may be capable of expanding the physical envelope in at least one direction. In another aspect of the present disclosure, the wireless device may also assume a form factor of a card capable of being inserted into a host device.

A further aspect of the present disclosure relates to a system for a storing and charging a wireless device. The system may include a wireless device and a power supply capable of supplying power to the wireless device. In an additional aspect, the present disclosure relates to a system for storage or charging of a wireless device that may exhibit a form factor of a card capable of being inserted into a host device.

Another aspect of the present disclosure relates to an earpiece that may include a flexible material, having a first shape. The earpiece may be capable of conforming to a second shape and expand in at least one dimension upon placement into a user's ear.

### BRIEF DESCRIPTION OF THE DRAWINGS

The detailed description below may be better understood with reference to the accompanying figures which are provided for illustrative purposes and are not to be considered as limiting any aspect of the invention.

FIG. 1 is a schematic view of a wireless device contemplated herein in communication with a host device.

FIG. 2a is a perspective view of wireless device contemplated herein.

FIG. 2b is a bottom view of the wireless device of FIG. 2a.

FIG. 2c is a front view of the wireless device of FIG. 2a.

FIG. 2d is a top view of the wireless device of FIG. 2a.

FIG. 2e is a side view of the wireless device of FIG. 2a.

FIG. 2f is a side view of the wireless device of FIG. 2a.

FIG. 3a is a perspective view of a wireless device contemplated herein in a relatively flat, collapsed configuration.

FIG. 3b is a perspective view of the wireless device of FIG. 3a in an expanded configuration.

FIG. 4a is a perspective view of a wireless device contemplated herein.

FIG. 4b is a perspective view of the wireless device of FIG. 4a, wherein the earpiece is rotated around axis B-B defined by the arm.

FIG. 5a is a side view of a wireless device contemplated herein having an ovoid shaped earpiece that may be thicker than the thickness of the housing of the wireless device.

FIG. 5b is a side view of a wireless device contemplated herein having an earpiece that may be as thick as or less than the housing of the wireless device.

FIG. 6a is a side view of a wireless device contemplated herein, illustrating a side view of the earpiece, wherein the earpiece is in a first configuration and uncompressed.

FIG. 6b is a rear view of the wireless device of FIG. 6a, illustrating a rear view of the earpiece.

FIG. 6c is a side view of the wireless device of FIG. 6a, illustrating a side view of the earpiece, wherein the earpiece is in a second configuration, as may be seen when inserted into an ear canal.

FIG. 6d is a rear view of the wireless device of FIG. 6c, illustrating a rear view of the earpiece, wherein the earpiece is in the second configuration.

FIG. 7a is a perspective view of a wireless device contemplated herein in a first collapsed state.

FIG. 7b is a perspective view of the wireless device of FIG. 7b in a second expanded state.

FIG. 8 is an exploded view of a wireless device contemplated herein illustrating the removable cover and shoulder cap.

FIG. 9a is a perspective view of a wireless device contemplated herein having a power supply and supply adapter as connected to the wireless device.

FIG. 9b is an exploded view of the wireless device and adapter and power supply of FIG. 9a.

FIG. 10a is a perspective view of a cradle for retaining a wireless device contemplated herein.

FIG. 10b is a rear view of the cradle of FIG. 10a.

FIG. 10c is a perspective view of the cradle of FIG. 10a including a wireless device retained therein.

FIG. 11a is a perspective view of a cradle including a clip for retaining a wireless device contemplated herein.

FIG. 11b is a perspective view of the cradle of FIG. 11a including a wireless device retained therein.

FIG. 12a is an exploded view of a wireless device and a cradle for retaining said wireless device having a form factor of a slot.

FIG. 12b is a schematic drawing of a wireless device, located in a card, positioned within a slot in a host device.

FIG. 13a is a perspective view of a cradle for retaining a wireless device having a form factor of an ExpressCard for an ExpressCard slot.

FIG. 13b is a perspective view of the cradle of FIG. 13a including a wireless device retained therein.

FIG. 14a is a perspective view of a cradle for retaining a wireless device having a form factor of a PCMCIA card for a PCMCIA slot.

FIG. 14b is a perspective view of the cradle of FIG. 14a including the wireless device retained therein.

FIG. 15a is a perspective view of a wireless device contemplated herein in a collapsed configuration.

FIG. 15b is a perspective view of the wireless device of FIG. 15a in an expanded configuration.

FIG. 16a is a perspective view of a wireless device contemplated herein in a collapsed configuration.

FIG. 16b is a perspective view of the wireless device of FIG. 16a in an expanded configuration.

FIG. 17a is a perspective view of a host device including a recess defined therein for retaining a wireless device.

FIG. 17b is a perspective view of a host device including a cradle having a wireless device retained therein.

FIG. 17c is an exploded view of the host device, cradle and wireless device of FIG. 17b including electrical contacts in the cradle and host device for transferring power and/or data to the wireless device.

FIG. 18a is a perspective view of a case for retaining a wireless device in a closed configuration.

FIG. 18b is a perspective view of the case of FIG. 18a including a wireless device retained therein.

FIG. 19a is a perspective view of a wireless device contemplated herein in a collapsed configuration.

FIG. 19b is a perspective view of the wireless device of FIG. 19a in an expanded configuration.

### DETAILED DESCRIPTION

The present invention relates to a device that when in a first configuration, such as when expanded, becomes a wireless mono or stereo headset and when in a second configuration, such as when collapsed, may be stored and charged.

In an exemplary embodiment the device may have an articulating ear piece that when expanded may fit into or over the ear. When collapsed the earpiece may be situated in a plane with the housing of the headset creating a product thickness of, e.g., about 5 mm or less. The relatively thin shape may allow the headset to be stored and charged in a portable cradle or with a mini USB charger. The portable cradle may be a holder, clip, case or card that may fit inside a standard expansion slot conforming to any expansion slot standard including, for example, PCMCIA, ExpressCard54 and ExpressCard34, etc. Additionally a unique slot or cavity may be designed into a laptop or cell phone or any other communication device that may utilize a speaker and microphone to accommodate such as a wireless headset.

Expanding on the above, the overall size and shape of the headset may be designed to accommodate or fit within the form factor of a standard expansion slot. For example, the device itself may be 24 mm×60 mm×5 mm when folded for storage purposes. A 34 mm×75 mm×5 mm headset cradle may be provided which may accommodate and fit within the size of a standard Expresscard 34 card. Such device may fit into the 34 mm Expresscard slot for storage and charging inside a portable computer. Once again, it should be appreciated that different form factors are also contemplated and may include the ExpressCard 54 or PCMCIA form factors as well as a form factor that may be later specifically developed for such a wireless device. Furthermore, the device itself may be relatively light in weight. An exemplary device may weigh less than 20 grams and in certain embodiments, less than 10 grams.

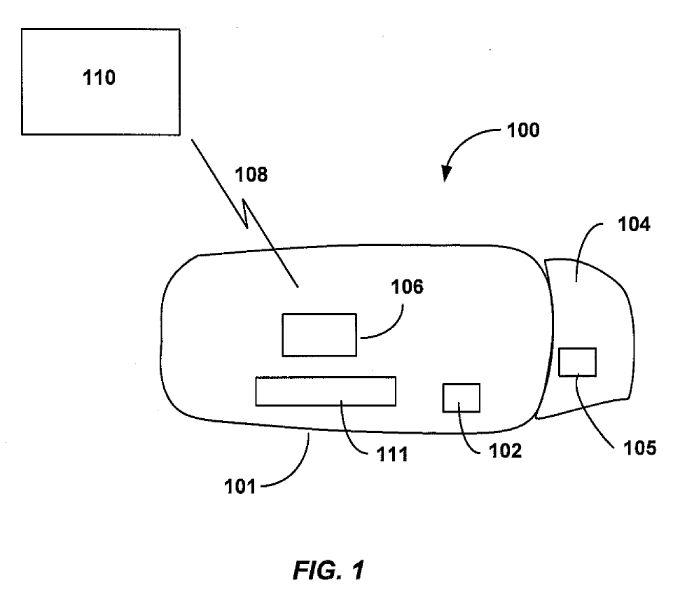

As illustrated in FIG. 1, the wireless device 100 may include a housing 101 a microphone 102 and an earpiece 104. A speaker 105 may direct sound through the earpiece. In addition, the wireless device may include a transceiver 106 for sending and receiving information 108 from a host device 110, such as a computer, a cell phone or a media player, including music players, dvd players or a television. Furthermore, the device may include a power source 111, such as a battery. The power source may be a rechargeable source or the power source may be replaceable. For example, the power source may utilize a rechargeable battery or a replaceable battery.

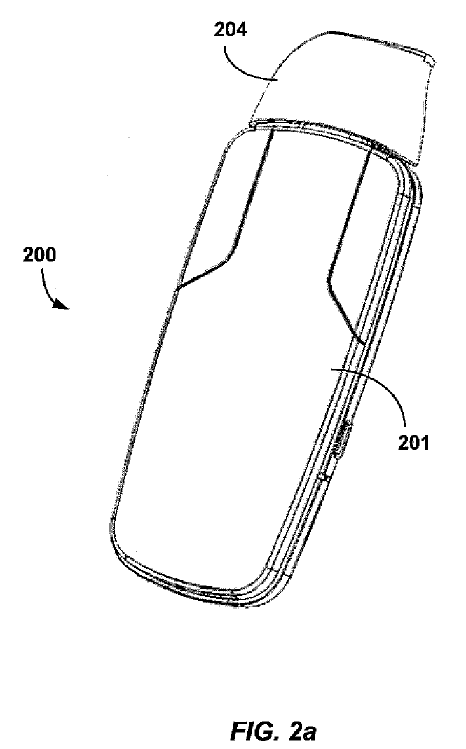

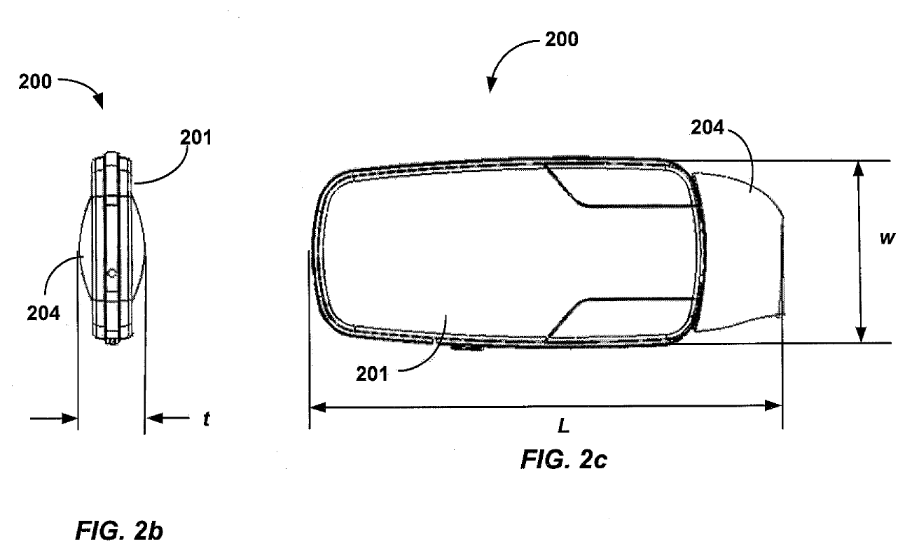

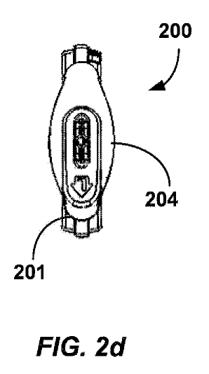

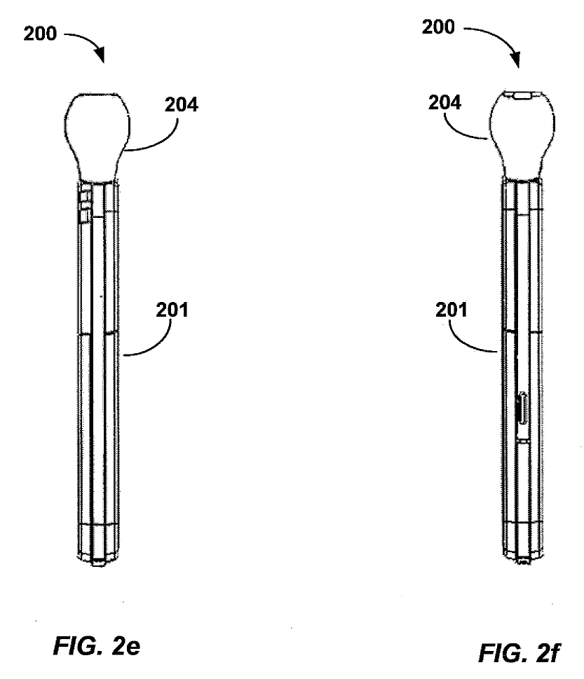

As alluded to above, the wireless headset may be expandable having a first configuration, that when expanded may be used as a wireless mono or stereo headset and when in a second configuration may be collapsed and stored. FIGS. 2a through 2f illustrate various views of an exemplary embodiment of a wireless device 200, illustrating the speaker 204 in a collapsed position against the housing 201. It may also be appreciated from the illustrations of FIGS. 2a through 2f, that the device 200 may have a physical envelope. The physical envelope may be defined by a length “L”, width “w” and thickness “t”, as illustrated in FIGS. 2b and 2c, or other appropriate dimensions.

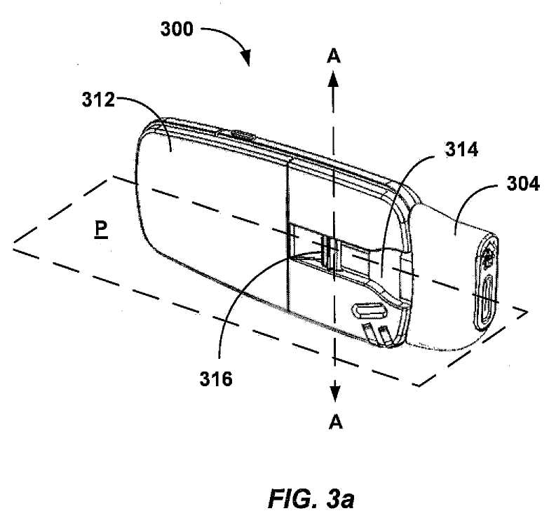

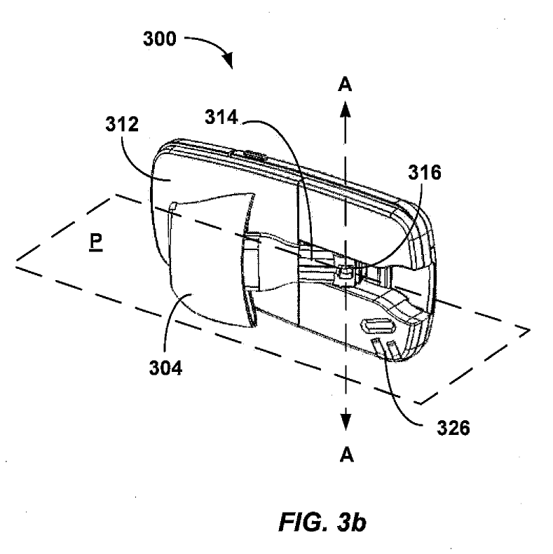

FIGS. 3a and 3b illustrate the back side 312 of the wireless device 300 in both the collapsed and expanded state. As can be seen in the figures, the speaker or earpiece 304 may be provided on an arm or boom 314 that may rotate away from the wireless device 300 in or through plane “P” perpendicular to a side 312 of the device 300 or around axis “A-A” defined by the hinge connection 316. Rotational motion may be provided by a hinge connection 316 between the arm 314 and device 300. Accordingly, upon expansion of the earpiece, the physical envelope of the wireless device may change in at least one dimension. Furthermore, detents may be provided at various angles through the rotation of the arm allowing for mechanical resistance to motion once the earpiece 304 has been placed at a desired angle.

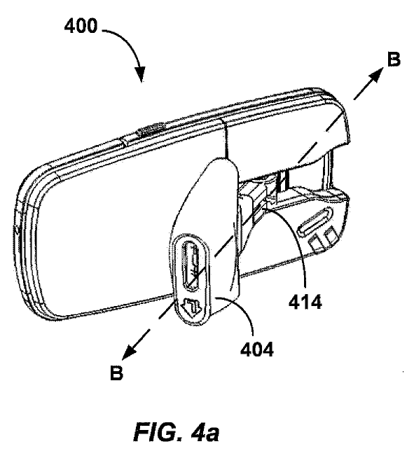

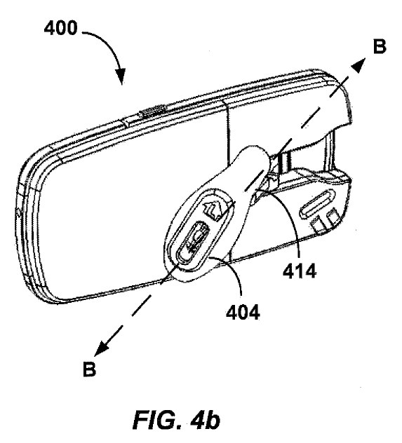

In addition to rotational motion of the arm in a plane perpendicular to the back side of the device, FIGS. 4a and 4b illustrate a further embodiment, wherein the speaker 404 may also be rotated about the axis “B-B” of the arm 414. FIG. 4a illustrates the earpiece 404 as the arm may rotate outward from the back of the device and FIG. 4b illustrates the earpiece as it may rotate around the axis of the arm. Detents may be similarly provided at various angles of rotation of the ear piece around the arm axis.

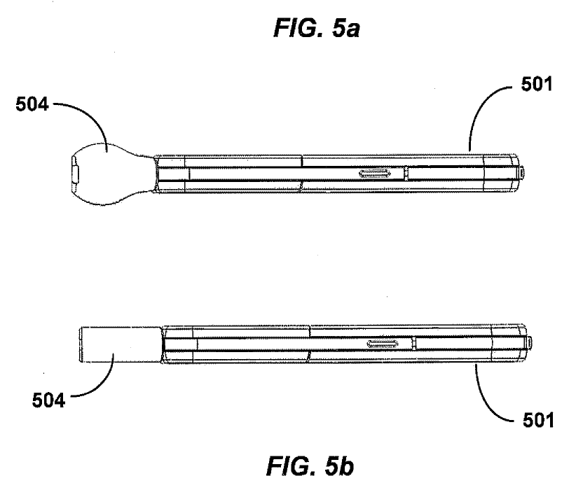

The earpiece may also be provided in a number of geometries, as illustrated in FIGS. 5a and 5b. FIG. 5a illustrates the earpiece 504 in first geometry, wherein the earpiece 504 may be ovoid and thicker than the housing 501 of the wireless device 500. FIG. 5b illustrates the earpiece 504 having a second geometry wherein the earpiece may assume a thickness similar to the housing 501, or the earpiece 504 may exhibit a thickness less than that of the housing 501. Accordingly, it may be appreciated that at least a portion of the earpiece may fit within a user's ear. In addition, the earpiece may be utilized to retain the wireless device on the user's ear.

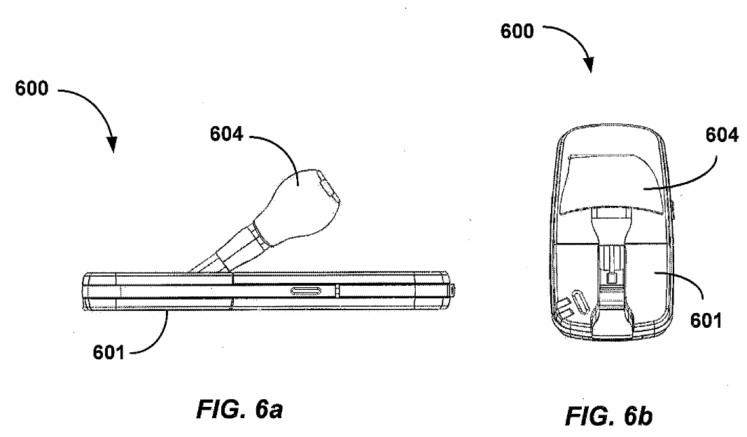

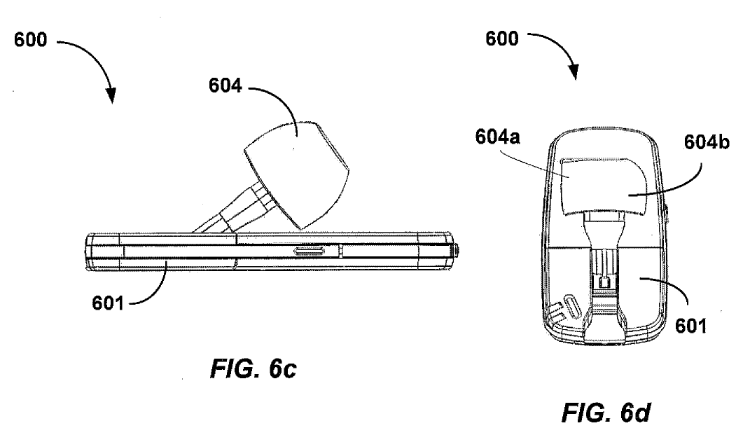

Furthermore, regardless of the geometry, the earpiece may be provided with a flexible and expandable material, which may exhibit elastic deformation and recovery. The flexible material may include polymeric materials, such a rubber, silicone, thermoplastic elastomers, etc. FIGS. 6a through 6d, illustrate conformation of an earpiece 604 having an ovoid shape. As the earpiece is inserted into an ear, such as in the tragus slot, the earpiece may deform from a first geometry, as illustrated in FIGS. 6a and 6b, into a second geometry illustrated in FIGS. 6c and 6d. The second geometry may be more curvate in shape and may conform to an ear canal, sealing of the earpiece in the ear to achieve improved sound characteristics or improved retention within the ear. In addition, it may be noted that the cross sectional geometry of the earpiece may include a thinner portion 604a on one end of the earpiece and a thicker portion 604b near another end of the earpiece, the thinner portion may accommodate the tragus slot, whereas the thicker portion may accommodate the remainder of the ear canal.

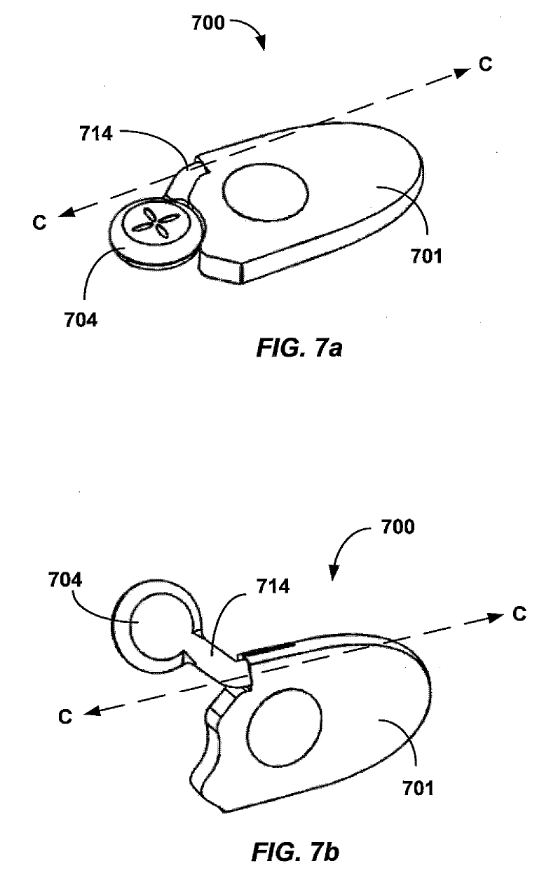

To further aid in adjustment of the fit of the earpiece, FIGS. 7a and 7b illustrate a configuration of the device 700, wherein the earpiece 704 may be provided on a pivoting arm 714, which may pivot around axis “C-C” defined by the arm. FIG. 7a illustrates the wireless headset wherein the earpiece 704 may be in a collapsed or storage configuration and FIG. 7b illustrates the wireless headset wherein the earpiece may be in an expanded configuration.

The wireless headset may also be provided with other design features. For example, FIG. 8 illustrates an exploded view of the device 800 including a housing 801, a removable cover 820, and a shoulder cap 822. The device, housing cover and shoulder cap may be assembled by positioning the shoulder cap onto the device and then placing the cover over the shoulder cap. The cover 820 and shoulder cap 822 may be retained on the housing 801 by one or more mechanical fasteners, such as by snap fits or press fits located around the cover and/or shoulder. Such removable cover and shoulder cap may provide a number of design configurations, including pieces having interchangeable colors, designs or shapes, depending on user or manufacturer preference.

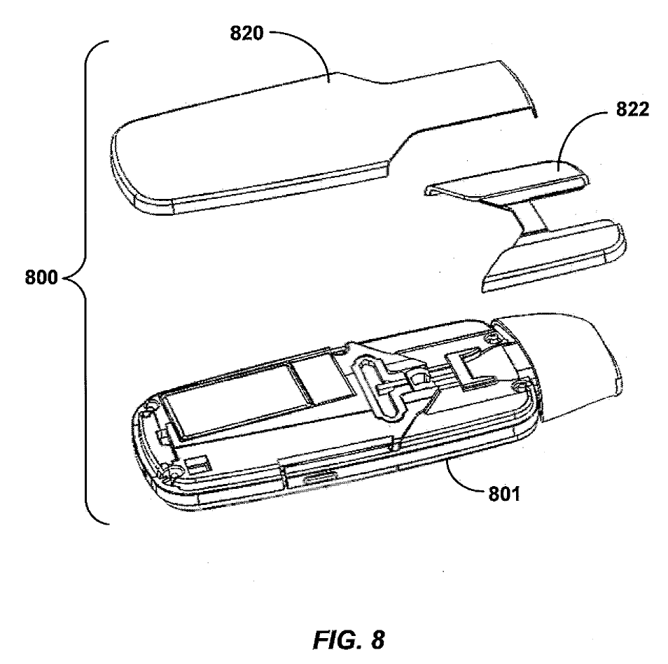

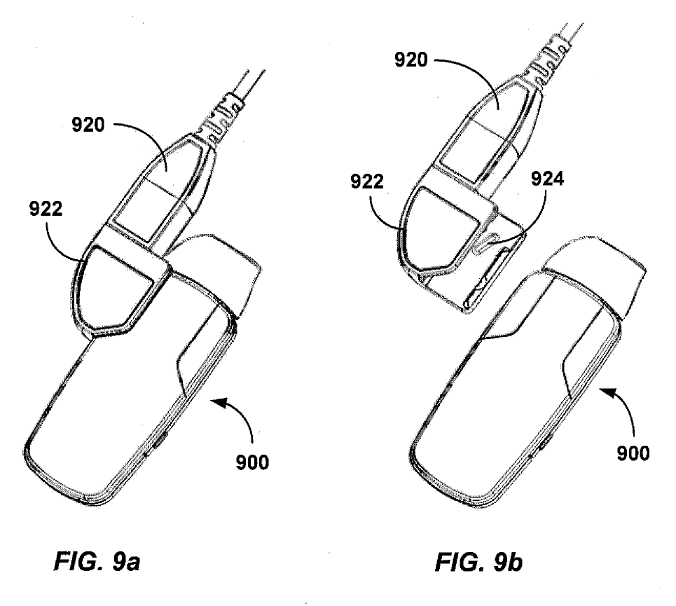

The wireless device may be stored and charged by a number of devices. In one example, the device may be directly charged by a micro or mini USB. The USB connector may be inserted into the device or an adapter for communication between the wireless device and USB may be provided. FIGS. 9a and 9b illustrate the use of a mini USB connector 920 provided with an adapter 922. The adapter may slide over a shoulder of the device in a detent left by the shoulder cap. The USB connector 920 may apply power to the adapter 922, which may then apply power to the wireless headset 900 via electrical contacts 924 on the adapter and electrical contacts located on the wireless headset, illustrated in FIG. 3b as 326. As illustrated, the adapter may be formed in a manner that may reduce the stress on the electrical connection between the adapter and wireless device. For example, the adapter may be formed so as to slide or latch onto a portion of the wireless device, preventing, e.g., torsional motion between the adapter and device.

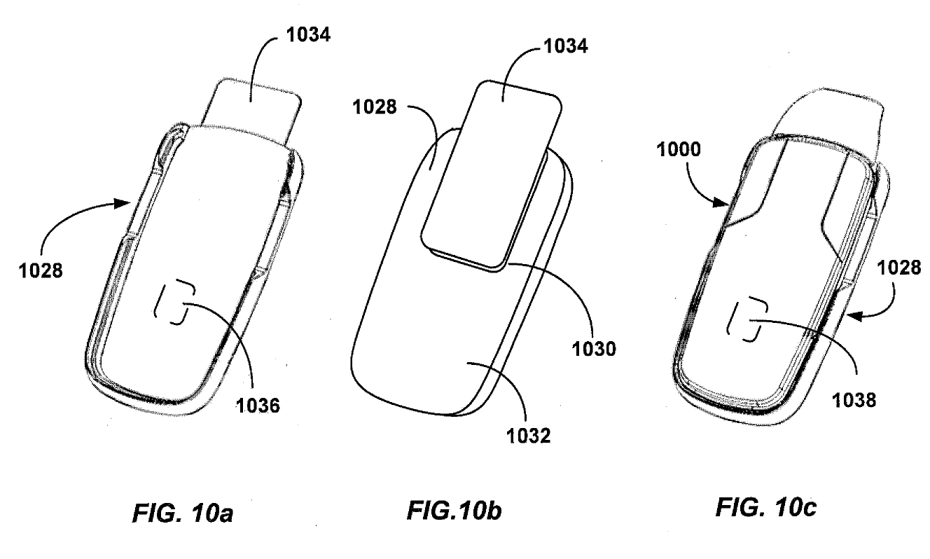

In another example, a cradle may also be provided for the device. FIGS. 10a through 10c illustrate a cradle 1028 in which the wireless device 1000 may be inserted. The cradle 1028 may have a double sided adhesive 1030 placed on the back 1032, wherein one side of the adhesive is affixed to the cradle 1028 and an adhesive backing 1034 remains until the user peels the backing and affixes the cradle to a surface. The surface may be any surface, such as that of a host device or another portable device. The cradle may also be provided with a power supply adapter for the wireless device, or the wireless device may be connected to a separate adapter while located in the cradle.

The device 1000 may be held to the cradle by a magnet 1036, which may be embedded in the cradle 1028. The wireless device 1000 may also include a ferromagnetic portion 1038, such as another magnet or ferrous material to which the magnet in the cradle may be attracted. The wireless device may also be held to the cradle by mechanical means, such as a bendable clip or protrusion that retains the wireless headset to the cradle.

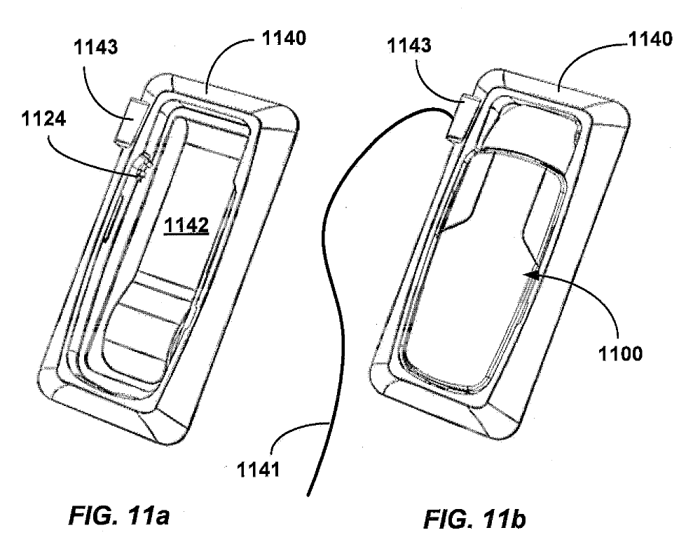

As illustrated in FIGS. 11a through 11b, the cradle may also include a holder 1140 that may be clipped onto a belt, shirt pocket or hung around the neck. The clip 1142 may be an integral portion of the holder or may include, for example, a spring loaded lever. Once again, the holder may be provided with a power supply adapter 1143, such as a USB adapter for receiving a USB plug to electrically connect the wireless headset to a USB plug. As illustrated in FIG. 11a, the electrical contacts 1124 may be provided in the holder 1140 for engaging electrical contacts (326 illustrated in FIG. 3) on the wireless device. FIG. 11b illustrates a cable 1141 providing a power supply, such as a USB cable, plugged into the power supply adapter 1143. In addition to power transfer, additional contacts may be provided for data transfer purposes between a host device and the wireless headset.

In another example, the wireless headset may be stored and charged in a cradle that may have attributes, such as a form factor or configuration that may allow the cradle to be inserted into a slot in a host device. Or, the wireless headset itself may take on a form factor of a slot in a host device.

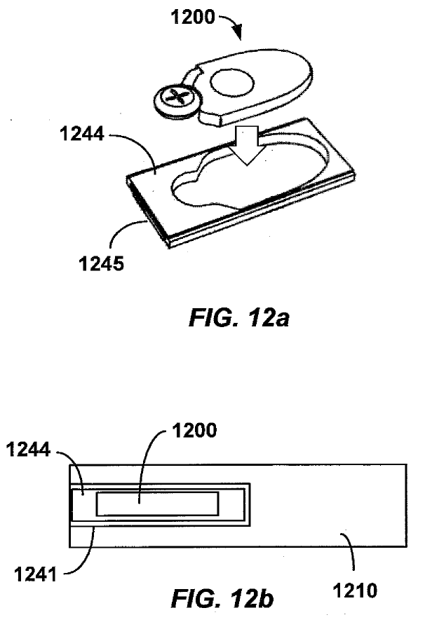

FIG. 12a illustrates a cradle 1244 for a wireless headset 1200 as shown in FIGS. 7a and 7b. The cradle 1244 may be in the shape of a card. The card may have a plug 1245 at an end capable of being engaged with or in a slot in a host device, or engaged by an adapter for providing power. As illustrated in FIG. 12b, the card may have the form factor of a slot 1241 that may be found in a host device 1210. As can be seen in FIG. 12b, at least a portion of, or the entirety of the cradle 1244 may be inserted into the slot. Once the headset has been charged, the cradle 1244 may be removed from the slot and the device may be removed from the card. The cradle may include battery charging circuitry, charge indicators, communication circuits and memory which in aggregate may provide some or all of the VOIP functionality.

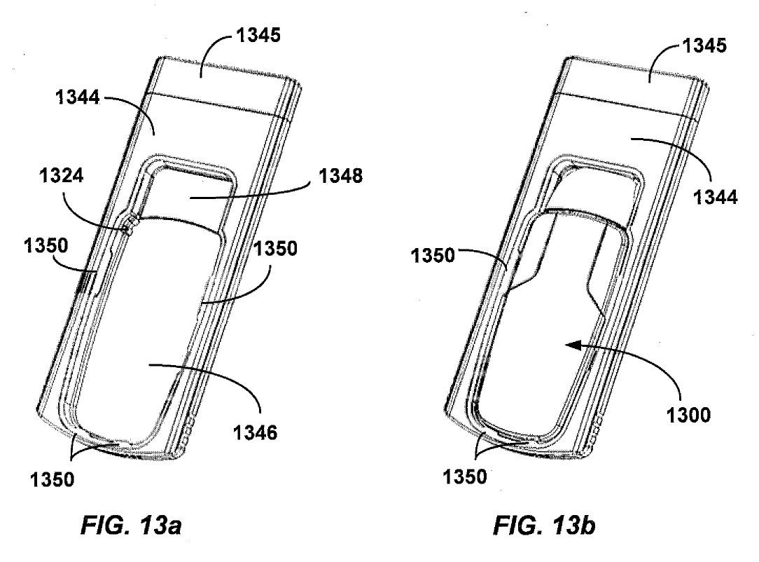

FIGS. 13a and 13b illustrate a cradle 1344 having the attributes of an ExpressCard™. As illustrated, the cradle may be 34 mm in width, 75 mm in length and 5 mm thick, or the cradle may be, for example, 54 mm in width, 75 mm in length and 5 mm thick. Either form factor may have a plug 1345, such as a 26 pin plug or other plug to accommodate a given host slot. The cradle may plug into an ExpressCard slot of a host device for storage or charging, or both. Thus, the host device may support, for example, both PCI express or USB 2.0 connectivity through the ExpressCard slot.

The cradle 1344 may be capable of receiving the wireless headset 1300 in a recess 1346 and providing power to the wireless headset for charging. As illustrated, the cradle may include a number of electrical contacts 1324 capable of engaging electrical contacts (326 illustrated in FIG. 3) in the wireless headset. In addition, the cradle may include a partial bottom cover 1348, which may prevent accidental rotation of the earpiece when the carrier is inserted into or removed from a host device. Other than one side of the ear piece, the wireless headset may remain exposed in the remainder of the recess. Stated another way, the wireless headset may form a portion of the surface of the card. Once again, the wireless device 1300 may be retained in the cradle 1344 via mechanical means. For example a retaining protrusion 1350 may be provided in a number of positions around the cradle 1344.

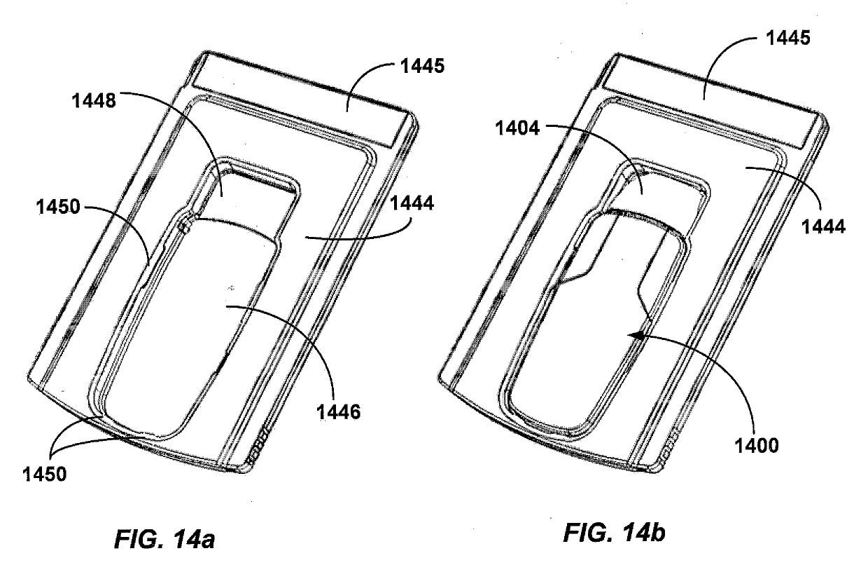

FIGS. 14a and 14b illustrate an embodiment wherein the cradle 1444 may assume the attributes of a PCMCIA card or PC card, having a recess therein 1446 to accommodate the wireless headset 1400. The PCMCIA card may be 85.6 mm long, 54 mm in width and 5 mm in thickness. The end of the PCMCIA card may have a plug 1445, which may include up to 68 pins, or as may be required by a given host device. The card may plug into a PCMCIA slot in a host device and the plug may provide an electrical connection between the host device and the wireless device.

Similar to the above ExpressCard cradle, the wireless headset may be retained in the recess of the PCMCIA cradle by mechanical protrusions 1450. The cradle may include a partial bottom cover 1448 located in proximity to the earpiece 1404 of the device 1400 to prevent the earpiece from rotating open during storage or upon removal from storage. The remainder of the wireless headset may remain exposed within the recess and may, therefore, form a portion of the card surface itself.

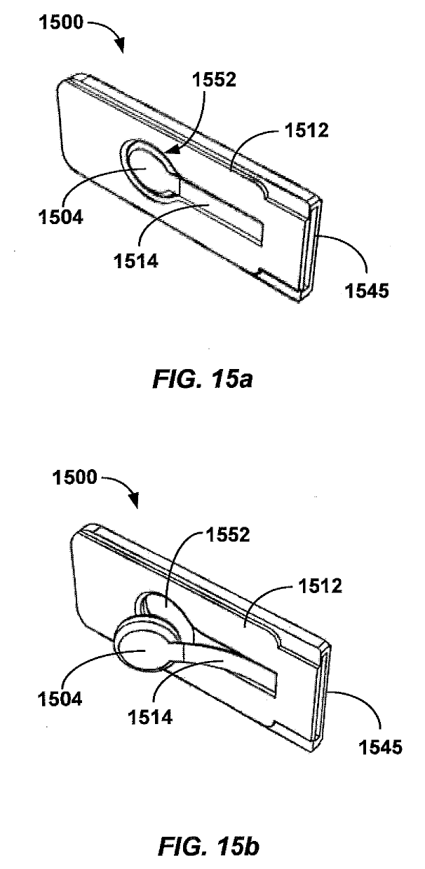

In addition, as noted above, the wireless headset itself may be of a form factor of a card slot and include a plug for engaging the portable computer or cell phone built into the headset. Illustrated in FIGS. 15a and 15b is such a device, wherein the wireless headset 1500 maybe provided in the form factor of a card, such as an ExpressCard. The wireless device 1500 may include an earpiece 1504 having a speaker and an arm 1514. The arm may pivot out from the back of the card 1512. As illustrated, the arm may be flexible and may pivot in a number of directions. A recess 1552 may be provided in the card to accommodate for the earpiece 1504 and arm 1514, which may be retained in the wireless headset when not in use. Retention of the earpiece and arm may be by mechanical means or a function of the material, due to elastic recovery. The wireless headset 1500 may then be plugged directly into a host device by plug 1545 in which the card may be stored and/or charged.

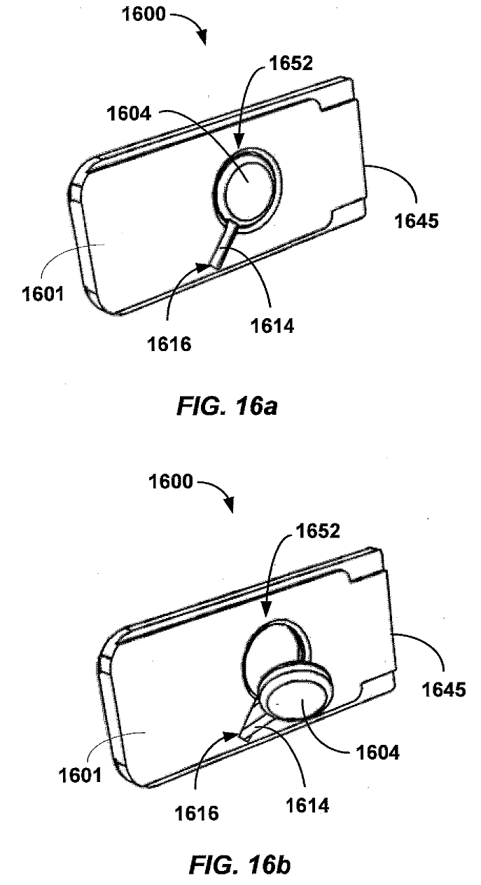

FIGS. 16a and 16b illustrate a second embodiment, wherein the wireless headset 1600 may be provided in the form factor of a card. Similar to the device illustrated in FIG. 3, the arm 1614 may pivot around a hinge 1616. In addition, in this embodiment, the speaker 1604 may pivot away from the card plug 1645, rather than towards the plug, as illustrated in FIGS. 15a and 15b. Once again, the arm 1614 and speaker 1604 may be stored in a recess 1652 in the device housing. It may be appreciated that a headset with a compliant earpiece arm may provide a retention force between the speaker 1604 and the housing 1601 of the headset that aids in the retention of the headset on the user. Such retention force may be provided by the given resistance in the pivot point 1616 or in the flex arm 1614.

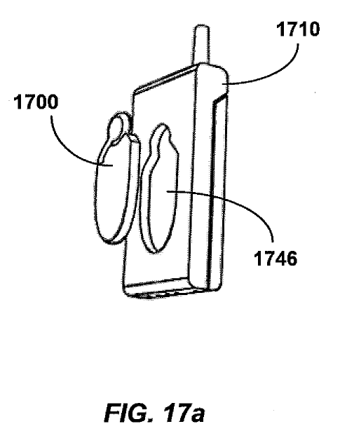

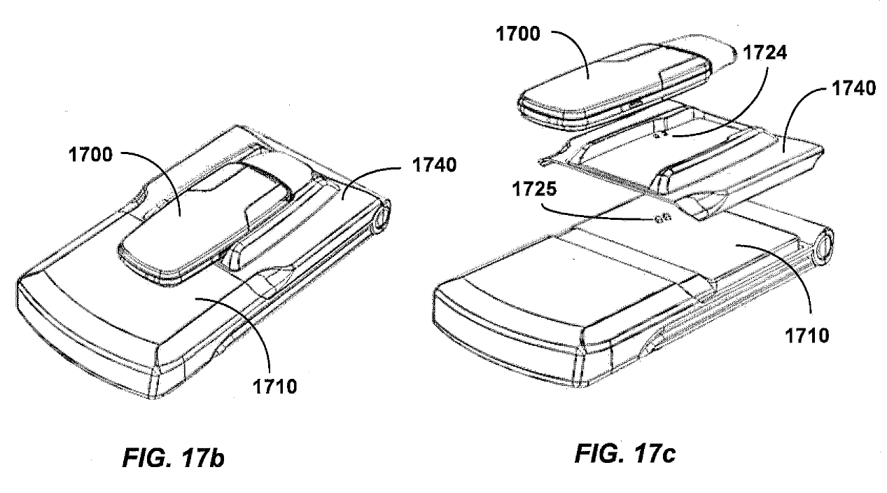

In a further example illustrated in FIGS. 17a through 17c, the wireless device 1700 may be provided on the host device 1710 itself. While the host device as illustrated is a mobile phone, other devices may be provided, such as a portable music player, laptop, etc. For example, as illustrated in FIG. 17a, the host device 1710 may define a recess 1746 therein which may receive the wireless device 1700.

In another example, illustrated in FIGS. 17b through 17c, a cradle 1740 may be provided that may be retained onto the host device 1710. A recess 1746 may be defined within the cradle 1740 for retaining the wireless device 1700. Power may be supplied by host device 1710 either directly to the wireless device 1700 or to the cradle 1740 and then to the wireless device 1700 through electrical contacts 1725 of the host device and/or contacts 1724 of the cradle 1740.

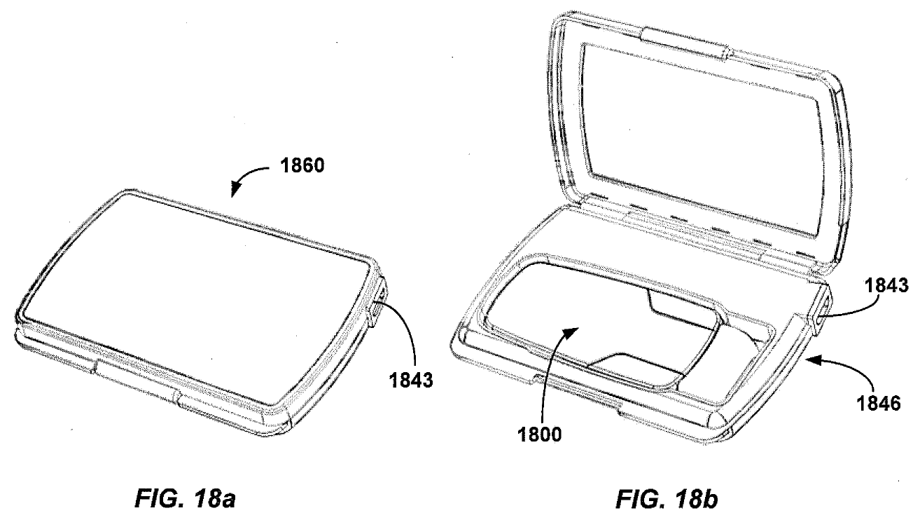

In another embodiment, as illustrated in FIG. 18, the wireless device 1800 may be provided in a case 1860, such as a clamshell case. The case may have a recess 1846 defined therein to accommodate the wireless device. The case may contain a reserve power supply, such as a reserve battery and charging circuitry. The case may include a power supply adapter 1843 for receiving power embedded in the case. The power supply adapter may be capable of receiving USB connector, including USB connectors of mini or micro format, or other connector capable of supplying power or data. Thus, the wireless headset and case may be charged together and the wireless headset may receive data from a host device. The case may include an indicator light indicating when the battery of the headset has reached full charge. Full charge may provide for up to 20 hours of talk time, however it should be appreciated that talk time may be determined by factors such as the type of battery used in the wireless device, the range of the wireless device from a host device, etc.

When not engaged with a slot or recess in a host device, the wireless headset may communicate with a host device wirelessly using various communication protocols, such as Bluetooth, 802.11, RF, etc. The host device (i.e. portable computer or cell phone) may include a transceiver for communicating with the wireless device. Wherein a cradle may be used, a transceiver receiver may be incorporated into the cradle and particularly, when the transceiver is not already a built-in function of the host device. When engaged within a slot, the wireless headset may incorporate connectors, circuitry, software or may otherwise be configured to allow the device to communicate with the host device (i.e. portable computer or cell phone) via PCMCIA or ExpressCard or other protocols of the slot. Furthermore, the device may include a rechargeable battery and may recharge when placed within the slot.

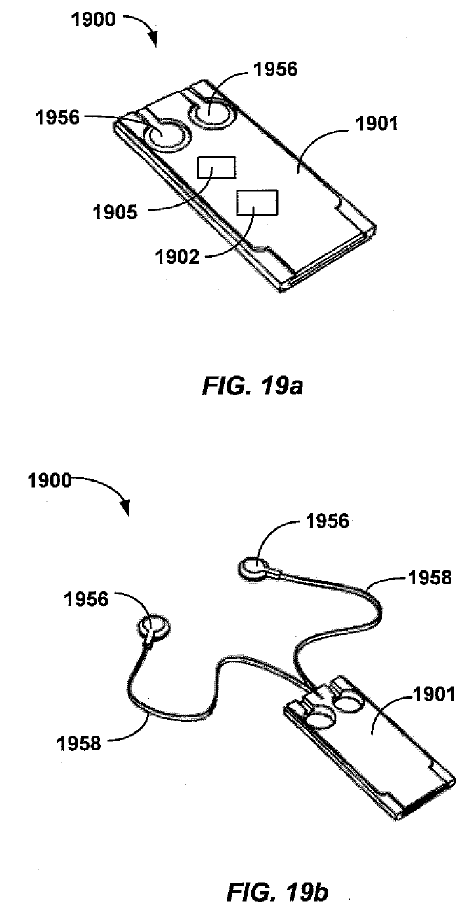

It should be appreciated that other headset type devices are contemplated herein, for example, in a further exemplary embodiment of a wireless device may be a wireless stereo headset that stores and charges in an expansion slot of a portable or handheld host device. Accordingly, such a headset may include speakers and/or a microphone. For example, as illustrated in FIGS. 19a and 19b, the wireless device 1900 may consist of one or more speakers, such as two speakers 1956 that when extended may fit inside the right and left ears for stereo sound. The speakers 1956 may be wired to a housing 1901 which may rest on the chest of a user similar to a pendant. The housing 1901 may be in the form factor of a PC Card or ExpressCard54 or ExpressCard 34.

As illustrated in FIG. 19b, when stored, the speakers 1956/wires 1958 may retract and/or coil up inside the housing 1901, which may allow the entire unit to store and charge in a host device. When the speakers 1956/wires 1958 are retracted and stored the unit may measure 5 mm thick or less and complies with all other dimensions of the card slot standard. The base housing may include a wireless radio (e.g., Bluetooth, 802.11, etc.) and battery. The headset may link with the host device to stream stereo sound.

The base housing may also include a microphone 1902 for communicating with the laptop using VOIP Technology. The base housing may also contain memory 1905 sufficient to provide VOIP software, address book storage and user identification data. In addition, the memory may also be used for storing any data such as audio, documents etc. A dial pad and interface indicators may also be present to provide standalone functionality as a phone.

It should be appreciated that while the above disclosure references portable computers and cellphones, this technology may also be translated to other portable devices, such as handheld devices, or even desktop devices where the clutter caused by cable management is undesirable.

The foregoing description is provided to illustrate and explain the present invention. However, the description hereinabove should not be considered to limit the scope of the invention set forth in the claims appended here to.

What is claimed is:

1. A wireless device comprising:
a housing;
a microphone;
a transceiver; and
a speaker which directs sound through an earpiece movably affixed to said housing, wherein at least a portion of said earpiece is configured to fit within a user's ear, and
wherein said wireless device has a physical envelope and said earpiece in an expanded configuration is capable of expanding said physical envelope in at least one direction.

2. The device of claim 1, wherein said earpiece is configured to rotate away from said housing.

3. The device of claim 1, wherein said earpiece is configured to rotate relative to said housing.

4. The device of claim 1, wherein said earpiece is formed from a flexible material having a first shape and is capable of conforming to a second shape.

5. The device of claim 1, wherein said a portion of said earpiece is configured to expand upon placement in a user's ear.

6. The device of claim 1, wherein said earpiece is capable of retaining said device in said user's ear.

7. The device of claim 1, further comprising a cradle for retaining said wireless device.

8. The device of claim 7, wherein said cradle is capable of charging said wireless device.

9. The device of claim 7, wherein said cradle includes a magnet, wherein said magnet is capable of magnetically affixing said wireless device to said cradle; and said cradle has a back surface and said cradle further comprises an adhesive disposed on said back surface.

10. A wireless device comprising:
a housing; and
a speaker in electrical communication with said housing, wherein said wireless device is capable of being inserted into a host device.

11. A system for a storing and charging a wireless device comprising:
a wireless device including a housing, a microphone, a transceiver, and a speaker which directs sound through an earpiece movably affixed to said housing, wherein at least a portion of said earpiece is configured to fit within a user's ear, and wherein said wireless device has a physical envelope and said earpiece in an expanded configuration is capable of expanding said physical envelope in at least one direction; and
a power supply capable of supplying power to said wireless device.

12. The system of claim 11, further comprising said a cradle capable of retaining said wireless device, wherein said cradle is configured to receive power from said power supply and includes second electrical contacts for engaging said first electrical contacts of said wireless device.

13. The system of claim 12, wherein said cradle further comprises a clip.

14. The system of claim 12, wherein said cradle exhibits the attributes of a card capable of being inserted into a host device.

15. The system of claim 14, wherein said form factor is of an ExpressCard.

16. The system of claim 14, wherein said form factor is of a PCMCIA card.

17. The system of claim 11, further comprising a host device providing said power supply.

18. The system of claim 17, wherein said host device includes a recess defined therein capable of retaining said wireless device and capable of engaging said first electrical contacts.

19. The system of claim 17, further comprising a cradle defining a recess therein, capable of retaining said wireless device, including second electrical contacts, wherein said cradle is remove-ably secured to said host device, receiving power from said host device and providing power to said wireless device through said first and second electrical contacts.

20. The system of claim 11, further comprising a case having a recess defined therein for said wireless device, wherein said case includes said power supply.

21. A system for storage or charging of a wireless device comprising:
a wireless device including a housing, a microphone, a transceiver, and a speaker which directs sound through an earpiece movably affixed to said housing, wherein at least a portion of said earpiece is configured to fit within a user's ear, and wherein said wireless device has a physical envelope and said earpiece in an expanded configuration is capable of expanding said physical envelope in at least one direction and said wireless device exhibits a form factor of a card capable of being inserted into a host device.

22. The system of claim 21, wherein said form factor is an ExpressCard.

23. The system of claim 21, wherein said form factor is a PCMCIA card.

24. The system of claim 21, further comprising a host device.

25. An earpiece comprising:
a flexible material, having a first shape and is capable of conforming to a second shape and expand in at least one dimension upon placement into a user's ear.
